(19) United States
(12) Patent Application Publication
(10) Pub. No.: US 2004/0130851 A1
(43) Pub. Date: Jul. 8, 2004

(54) Fluid deionization system

(76) Inventor: Sadeg M. Faris, Pleasantville, NY (US)

Correspondence Address: REVEO, INC., 85 Executive Boulevard, Elmsford, NY, 10523, US

(21) Appl. No.: 10/694,528

(22) Filed: Oct. 27, 2003

Related U.S. Application Data
(60) Provisional application No. 60/421,320, filed on Oct. 25, 2002.

(51) Int. Cl. H01G 9/00

(52) U.S. Cl. 361/503; 204/647

(57) ABSTRACT

A staged or serial deionization system is described. The system includes N deionization subsystems. The system has a charging state for deionizing fluid and a discharging state for deionizing the respective deionization subsystem. In the charging state, ionized fluid is discharged serially. In the discharging state, N deionization subsystems are discharged in parallel, thereby reducing the ecological impact of the discharge brine.

### RELATED APPLICATIONS

The present invention claims priority to U.S. Provisional Patent Application No. 60/421,320 filed on Oct. 25, 2002, which is incorporated by reference herein.

### BACKGROUND

Deionized water is employed in many commercial applications, such as semiconductor and chrome-plating plants, automobile factories, beverage production, and steel processing. Further, systems are contemplated in homes units, businesses, manufacturing and municipal facilities, and other applications that can recycle their water output, cutting costs and protecting the environment.

Of course, a prime objective of flow through capacitor technology entails the desalinization of sea water at a reasonable cost, providing an inexhaustible supply of usable water to regions in need. Presently, advanced research is underway using new materials including carbon nanotubes.

Nonetheless, the water demands of the Third World are immediate. Two-thirds of the world population do not have access to clean water. Most disease in the developing world is water-related—more than 5 million people a year die of easily preventable waterborne diseases such as diarrhea, dysentery and cholera.

Plainly stated, potable water will be the most valuable commodity in the future. The world's population will double in the 50 to 90 years. Per capita water consumption increases while the supply deteriorates. 80% of the world's population lives within 200 miles of a coastline where water is available but not potable or suitable for agriculture. 70% of the ground water is brackish. 85% of all illness is associated with unsafe drinking water.

Flow through capacitors have been developed to separate materials from fluid streams, such as salt from water. For example, Andleman U.S. Pat. Nos. 5,192,432, 5,186,115, 5,200,068, 5,360,540, 5,415,768, 5,547,581, 5,620,597, 5,415,768, and U.S. Pat. No. 5,538,611 to Toshiro Otowa, all of which are incorporated by reference herein, describe flow through capacitor systems which filters polluted and brackish water between alternating electrodes of activated carbon (the capacitors). Further, Faris PCT Application No. US02/25076 filed on Aug. 7, 2002 entitled “Movable Electrode Flow-Through Capacitor” and Faris et al. PCT Application No. US03/26693 filed on Aug. 26, 2003 entitled “Fluid Desalinization Flow Through Capacitor Systems”, both of which are incorporated herein by reference in their entireties, describe flow through capacitor systems with improved throughput. In general, when voltage is applied, salts, nitrates, totally dissolved solids and other adulterants in the water are attracted to the high surface area carbon material. Solids develop on the electrodes, and thus the process must be stopped to remove the contaminants as concentrated liquid. This is accomplished by short-circuiting of the electrodes.

This method has been taught as a better process for water desalinization than traditional systems like reverse osmosis, which passes through contaminants such as nitrates, promotes bacterial growth and wastes one or more gallons of water for every one it purifies. Further, ion exchange systems, also widely used, generate pollution and use strong acids, bases and salts to regenerate the resin.

However, limited lifetime of the electrodes results in high capital costs, and electrodes must be frequently replaced. Complex electrode support structures, intra-electrode and inter-electrode plumbing, and housings are difficult to recover from conventional flow through capacitor systems.

Further, another drawback of many conventional flow through capacitor and other deionization systems, particularly for economical water desalination, is the high concentrations of the discharged brine. It is not uncommon for conventional water desalinization plants to discharge brine directly into the ocean. This brine may have concentration up to and even greater then twice that of seawater. This creates unnatural regions of high salt concentration seawater, disrupting the ecological system. Thus, while achieving necessary goals of providing potable water to municipalities and a water source for irrigation, the unintended environmental and ecological impacts of conventional desalination plants and systems may ultimately outweigh the intended results.

Therefore, it is desirable to provide a relatively ecologically benign system and process to desalinate water, or to remove other substances from a material, as is needed.

### SUMMARY

The above-discussed and other problems and deficiencies of the prior art are overcome or alleviated by the several methods and apparatus of the present invention for removing ionic substances from fluids, such as removing salt from water.

A staged or serial deionization system is described. The system includes N deionization subsystems (e.g., flow through capacitors). The system has a charging state for deionizing fluid and a discharging state for deionizing the respective deionization subsystem. In the charging state, input ionized fluid having an ion concentration C is introduced in an Nth deionization subsystem for decreasing the concentration of the fluid by Δ_{N}, resulting in a fluid stream having a concentration C−Δ_{N}. The C−Δ_{N} fluid stream is inputted to a subsequent deionization subsystem and is charged therein by decreasing the concentration of the fluid by Δ_{N}. The process ultimately provides an output fluid stream having a concentration C−

$${\sum }_{k = 1}^{N} {Δ}_{k} .$$

To discharge the system, in certain preferred embodiments, the system is electrically shorted, and flush fluid having a concentration F is flushed in parallel through the N deionization subsystems. Accordingly, the maximum concentration of the brine (discharged fluid) is F+Δ_{M}, where ΔM is the largest value of the values ΔN. This is particularly advantageous over conventional systems that would discharge

$$C - {\sum }_{k = 1}^{N} {Δ}_{k} .$$

For example, if all of the values ΔN are approximately equal (Δ), and the flush fluid is the same inlet fluid to be deionized (F=C), then the discharge fluid from N subsystems would be approximately C−Δ, as opposed to conventional systems having discharge fluid concentrations of C−NΔ.

The above-discussed and other features and advantages of the present invention will be appreciated and understood by those skilled in the art from the following detailed description and drawings.

### BRIEF DESCRIPTION OF THE DRAWINGS

FIG. 1 is a schematic representation of a serial deionization system having parallel discharge mode; and

FIGS. 2A-2C depict another serial deionization system and modes of operation.

### DETAILED DESCRIPTION

Herein disclosed is a serial deionization system. The serial deionization system allows for a system configuration that is modular, scaleable, rapidly deionizing, and efficient.

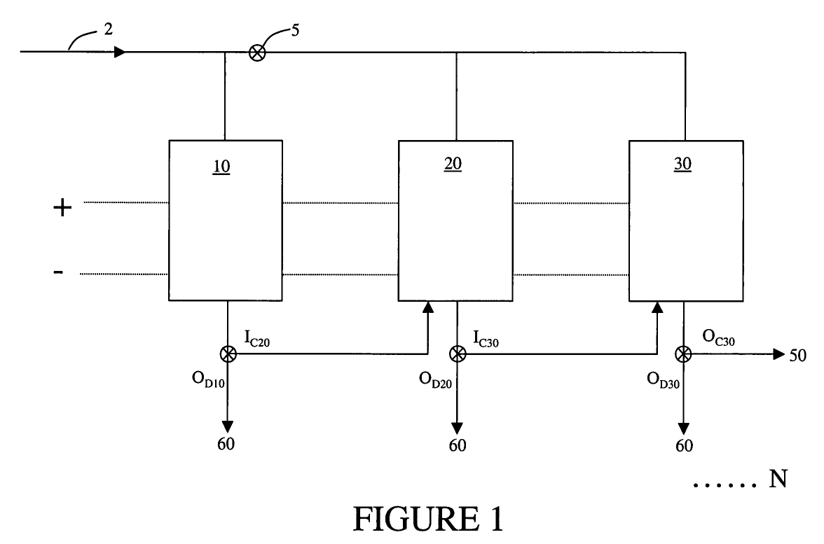

Referring to FIG. 1, a system 100 for de-ionizing a fluid is described. The system 100 includes a plurality of deionization subsystems 10, 20, 30 . . . N, such as flow through capacitors. Three are shown for convenience, thus it is intended that any number from 2 to N may be used in the system, wherein N may be as few as 2 and as many as needed for the application (e.g., 10s, 100s, 1000s).

The flow through capacitors are electrically connected to a power source, and the power connection is configured to alternate, for example, for alternating charging functions (e.g., deionizing fluid flowing through flow through capacitors) or discharging functions (e.g., deionizing collected ions from flow through capacitors). The power source may be DC or AC. In DC operations, the polarities may be reversed to switch between charging and discharging. In AC operations, for example, phases may be alternated to vary charging and discharging cycles.

During charging (fluid deionization) operations, ionized fluid having a concentration C is introduced via a stream 2 into the first deionization subsystem (e.g., flow through capacitor) 10. A valve 5 is in the “off” position, to prevent fluid with concentration C from entering deionization subsystems 20, 30, . . . N. A valve I_{C20}/O_{D10} is configured to allow flow to into the second deionization subsystem (e.g., flow through capacitor) 20. A valve I_{C30}/O_{D20} is configured to allow flow to into the third deionization subsystem (e.g., flow through capacitor) 30, and so on for N deionization systems. The deionization subsystems 10, 20, 30 . . . N each decreases the concentration of the respective incoming fluid stream by a value Δ₁₀, Δ₂₀, Δ₃₀, . . . Δ_{N}, wherein Δ₁₀, Δ₂₀, Δ₃₀, . . . Δ_{N} may each be the same or different. Therefore, the deionized fluid stream 50 has a concentration C−(Δ₁₀+Δ₂₀+Δ₃₀+ . . . Δ_{N}), and accordingly, if Δ₁₀, Δ₂₀, Δ₃₀, Δ_{N} are the same, the deionized fluid stream 50 has a concentration C−NΔ.

In other terms, a system including N deionization subsystems, each decreasing the concentration of the fluid (having an initial ion concentration of C) by Δ_{N}, a deionized output fluid stream results having a concentration

$$C - {\sum }_{k = 1}^{N} {Δ}_{k} .$$

In the discharging state (deionization system deionization), as shown in the example of FIG. 1, each system 10, 20, 30 . . . N receives an input from input stream 2, wherein valve 5 is open. The output valves for each subsystem 10, 20, 30 . . . N are configured to allow ionized fluid to exit via outlets 60.

A key benefit to the system of FIG. 1, referred to as “series charge/parallel discharge”, is that the discharge product only has a concentration in the range of C+Δ, which is environmentally safe, as compared to conventional deionization system outputs or brine discharge products.

In other terms, discharge of N cells using flush fluid having a concentration F results in maximum brine (discharged fluid) concentrations of F+Δ_{M}, where ΔM is the largest value of the values ΔN. This is particularly advantageous over conventional systems that would discharge

$$C - {\sum }_{k = 1}^{N} {Δ}_{k} .$$

The deionization subsystem, in the embodiment of FIG. 1 and in other embodiments herein, may comprise any known reverse osmosis system, ion exchange system, flow through capacitor system, or combination thereof. In certain preferred embodiments, a flow through capacitor system is used. Typical flow through capacitor systems include a pair of electrodes having a space therebetween for fluid flow. Upon application of a voltage (e.g., from a DC source, and contacting the electrodes via suitable contacts) and passage of an ionic fluid, ions of appropriate charge are attracted to the electrodes, forming an electric double layer.

A high surface area conductive constituent alone may be formed as the electrodes, or may be supported on appropriate substrates (conductive or non-conductive, depending on the form of the electrodes). Alternatively, a current collector and a high surface area conductive constituent may be in the form of layers, or may be a single layer, for example, as described in An exemplary air cathode is disclosed in U.S. Pat. No. 6,368,751, entitled “Electrochemical Electrode For Fuel Cell”, to Wayne Yao and Tsepin Tsai, filed on Oct. 8, 1999, which is incorporated herein by reference in its entirety.

The high surface area conductive material employed in the flow-through capacitor may comprise a wide variety of electrically conductive materials, including, but not limited to, graphite, activated carbon particles, activated carbon fibers, activated carbon particles formed integrally with a binder material, woven activated carbon fibrous sheets, woven activated carbon fibrous cloths, non-woven activated carbon fibrous sheets, non-woven activated carbon fibrous cloths; compressed activated carbon particles, compressed activated carbon particles fibers; azite, metal electrically conductive particles, metal electrically conductive fibers, acetylene black, noble metals, noble metal plated materials, fullerenes, conductive ceramics, conductive polymers, or any combination comprising at least one of the foregoing. The high surface area material may optionally include coatings or plating treatments with a conductive material, such as palladium, platinum series black, to enhance electrical conductivity. The high surface area material may also be treated with chemicals such as alkali, e.g., potassium hydroxide, or a halogen, e.g., fluorine; to increase the surface area and conductivity. Activated carbon material of greater than about 1000 square meters per gram surface area are preferred, but it is understood that lower surface area materials may also be employed, depending on factors including but not limited to the distance between the electrodes, the voltage applied, the desired degree of ion removal, the speed of the movable cathodes, and the configuration of the movable cathodes.

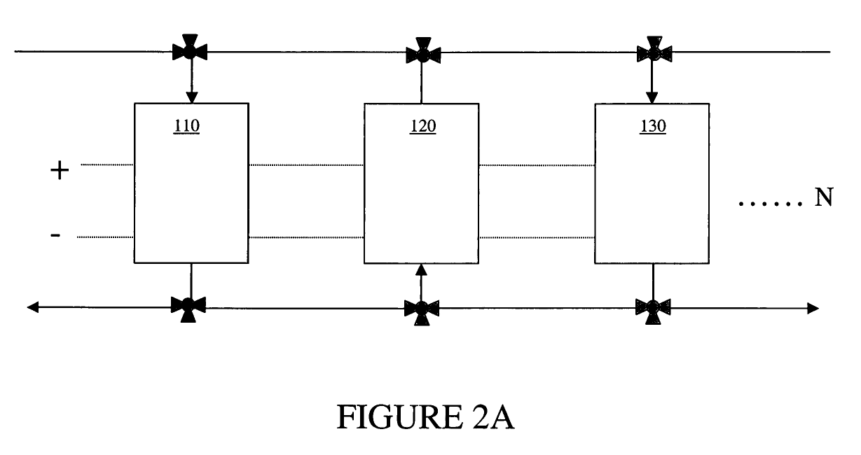

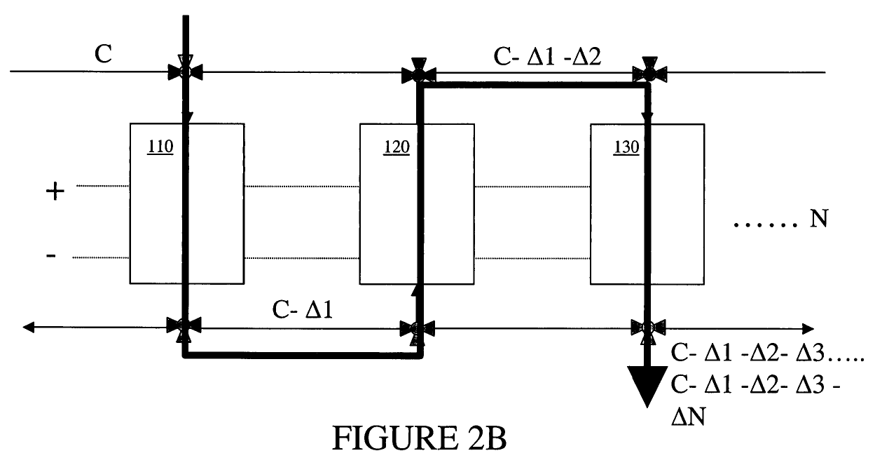

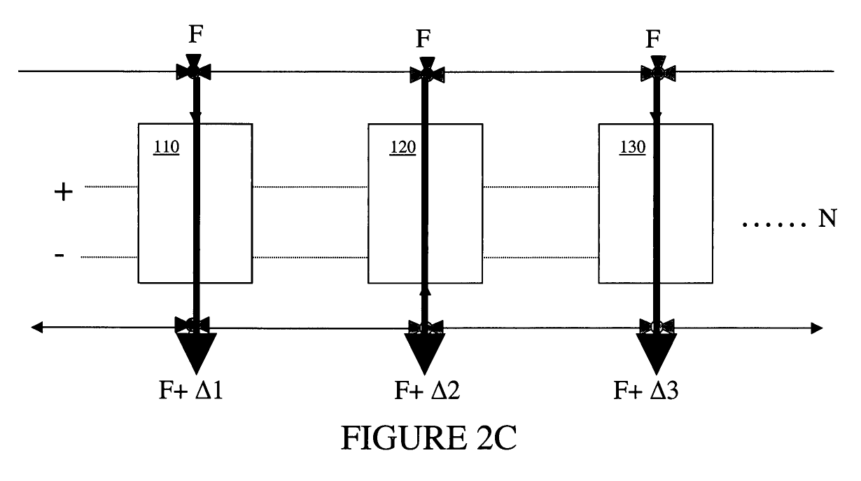

Referring now to FIGS. 2A-2C, a staged or serial deionization system is depicted. The system includes N flow through capacitors 110, 120, 130 . . . N electrically connected to a suitable power supply in a charging state for deionizing fluid and electrically shorted in a discharging state for deionizing the respective flow through capacitor.

In the charging state, as shown in FIG. 2B, input ionized fluid having an ion concentration C is introduced in the flow through capacitor 110, wherein the concentration of the fluid is decreased by Δ1 to a fluid stream having a concentration C−Δ1. The C−Δ1− fluid stream is inputted to flow through capacitor 120 and is charged therein by decreasing the concentration of the fluid by Δ2 to a deionized output fluid stream having a concentration C−Δ1−Δ2. Likewise, the C−Δ1−Δ2−Δ3 fluid stream is inputted to flow through capacitor 130 and is charged therein by decreasing the concentration of the fluid by Δ3 to a deionized output fluid stream having a concentration C−Δ1−Δ2−Δ3. Note that the Δ values may be the same or different, as described above.

In the discharging state, and referring now to FIG. 2C, a discharging input fluid having concentration F is inputted in parallel to the flow through capacitors 110, 120, 130. Output fluid from the flow through capacitors 110, 120, 130 having a concentration F+Δ1, F+Δ2, F+Δ3 is discharged from the system. Such a system is ecologically benign, especially compared to conventional systems that would discharge fluid having a concentration F+Δ1+Δ2+Δ3+ΔN.

In one preferred embodiment, the valving and plumbing arrangement is constructed to be reuseable, wherein the deionization units or flow through capacitors 110, 120, 130 (or 10, 20, 30) are modular and replaceable.

While preferred embodiments have been shown and described, various modifications and substitutions may be made thereto without departing from the spirit and scope of the invention. Accordingly, it is to be understood that the present invention has been described by way of illustrations and not limitation.

What is claimed is:

1. A staged deionization system comprising:
a first and second deionization subsystems having a charging state for deionizing fluid and a discharging state for deionizing the respective deionization subsystems, wherein
in the charging state,
input ionized fluid having an ion concentration C is introduced in the first deionization subsystem wherein the concentration of the fluid is decreased by Δ₁ to a fluid stream having a concentration C−Δ₁, and
the C−Δ₁ fluid stream is introduced to the second deionization subsystem and is charged in second deionization subsystem by decreasing the concentration of the fluid by Δ₂ to a deionized output fluid stream having a concentration C−(Δ₁+Δ₂), and wherein
in the discharging state,
flush fluid is inputted in parallel to the first deionization subsystem and second deionization subsystem, wherein ions that have built up in the first deionization subsystem and second deionization subsystem are discharged.

2. A staged deionization system comprising:
N deionization subsystems represented by k=1 through N, each having a charging state for deionizing fluid and a discharging state for deionizing the respective deionization subsystem, wherein
in the charging state, N serially connected systems each decrease the concentration of input fluid initially having a concentration C by an amount of Δₖ at each stage resulting in an output deionized fluid stream having a concentration
$$C - {\sum }_{k = 1}^{N} {Δ}_{k} ,$$
and wherein
in the discharging state, the N deionization subsystems are flushed in parallel with flush fluid having a concentration F, resulting in maximum discharged fluid concentrations of F+Δ_{M}, where ΔM is the largest value of the values Δk.

3. The staged deionization system as in one of claims 1 or 2, wherein at least one of the deionization sub-systems comprise flow through capacitors electrically connected to an electrical connection in the charging state and electrically shorted in the discharging state.

4. The staged deionization system as in one of claims 1 or 2, wherein fluid communication between input fluids, deionization systems, flush fluids, and discharge fluids is provided in the form of plumbing and valves configured and constructed to be reusable, and wherein the deionization systems are modular.
